(19) United States
(12) Patent Application Publication
(10) Pub. No.: US 2020/0169010 A1
(43) Pub. Date: May 28, 2020

(54) CONDUCTIVE MEMBER

(71) Applicant: SUMITOMO WIRING SYSTEMS, LTD., Yokkaichi-shi, Mie (JP)

(72) Inventor: Hirokazu NAKAI, Yokkaichi (JP)

(73) Assignee: SUMITOMO WIRING SYSTEMS, LTD., Yokkaichi-shi, Mie (JP)

(21) Appl. No.: 16/500,023

(22) PCT Filed: Mar. 19, 2018
(86) PCT No.: PCT/JP2018/010700

§ 371 Date: Oct. 1, 2019

(30) Foreign Application Priority Data
Apr. 7, 2017 (JP) 2017-077039

(51) Int. Cl. H01R 4/20; H01R 11/12; H01R 4/60; H01R 4/18

(52) U.S. Cl. CPC H01R 4/20; H01R 4/185; H01R 4/60; H01R 11/12

(57) ABSTRACT

A conductive member includes a conductive pipe and a terminal fitting having a first end and a second end, the first end being a hollow pipe connection part that is connected to the pipe, and the second end being a counterpart connection part that is connectable to a counterpart conductor part. The pipe connection part has a contact part that has a circular cross-section and is fitted into the pipe. The pipe has (i) a concave section that indents radially inward near one end of the pipe and (ii) a depression that indents radially inward, the depression being positioned at a greater distance, than the concave section, from the one end of the pipe, and the depression being formed deeper, than the concave section, in a radial direction of the pipe. An end of the pipe connection part abuts against and is stopped by the depression.

This invention relates to a conductive member.

### BACKGROUND

A conductive member disclosed in JP Published Patent Application No. 2016-219104A comprises a conductive pipe member, a coated wire that is connected to a terminal in the lengthwise direction of the pipe member, and a connection member that connects the coated wire and the conductive pipe member. At a tip end of the coated wire, a coating is peeled off, and a core wire is exposed. The connection member is provided with a concave section that opens at a coated wire side, and the core wire is accommodated in the concave section. A peripheral wall section of the concave section surrounds one end side of the core wire, is crimped over the entire circumference by hexagonal caulking or the like, and is crimped to one end side of the core wire. Thus, the core wire and the connection member are configured to be conductively connected.

### SUMMARY

In the above-described case, the connection member is interposed between the coated wire and the pipe member, so the number of components increases by that much. In addition, by having a flexible coated wire bent at one end of the conductive member, the position at the other end of the conductive member fluctuates, so it is difficult to confirm a position where the other end of the conductive member connects with the conductive part on the other side.

In consideration of the foregoing, it is an object of the present invention to provide a conductive member in which the number of components can be reduced, and in which the connection position at the end can be confirmed.

A conductive member of the present invention comprises: (i) a conductive pipe, and (ii) a terminal fitting having a first end and a second end, the first end being a hollow pipe connection part that is connectable to the pipe, and the second end being a counterpart connection part that is connected to a counterpart conductor part on the other end side, wherein the pipe connection part has a contact part that has a circular cross-section, is fitted into the pipe, and contacts the pipe along the circumferential direction, and the pipe has (i) a concave section that indents radially inward near one end of the pipe and (ii) a depression that indents radially inward, the depression being positioned at a greater distance, than the concave section, from the one end of the pipe, the depression being formed deeper, than the concave section, in a radial direction of the pipe, and an end of the pipe connection part abuts against and is stopped by the depression, and the connection part has a shape that indents radially inward in correspondence with the concave section.

Because the terminal fitting is directly connected to the pipe by the pipe connection part, not only is no separate connection member interposed between the terminal fitting and the pipe, but the core wire can also be omitted, enabling the number of components to be reduced. In addition, because positional fluctuation between the pipe and the terminal fitting substantially does not exist, it is possible for the side where the terminal fitting is positioned at the pipe and the other side on the end on the opposite side to easily reach connectable position, so it is possible to confirm the connection position of the end. Because the pipe connection part has a circular cross-section that can be fitted into the pipe and is made insertable into the pipe, the work of connecting the terminal fitting and the pipe can be accomplished smoothly. By having the contact part contact the pipe along the circumferential direction, it is possible to avoid contact resistance unnecessarily rising. By having the pipe connection part fitted inside the pipe, it is possible to avoid the conductive member becoming excessively large in the radial direction. In addition, because the connection part has a shape that indents in correspondence with the concave section of the pipe, it is possible to realize a mechanical connection through an engagement stop action between the contact part and the concave section. By having the end of the pipe connection part abut against and be stopped by the depression, it is possible to easily confirm the amount of insertion of the pipe connection part into the pipe.

### BRIEF DESCRIPTION OF THE DRAWINGS

FIG. 1 is a perspective view of a conductive member according to a first embodiment of this invention.

FIG. 2 is a cross-sectional view of the conductive member.

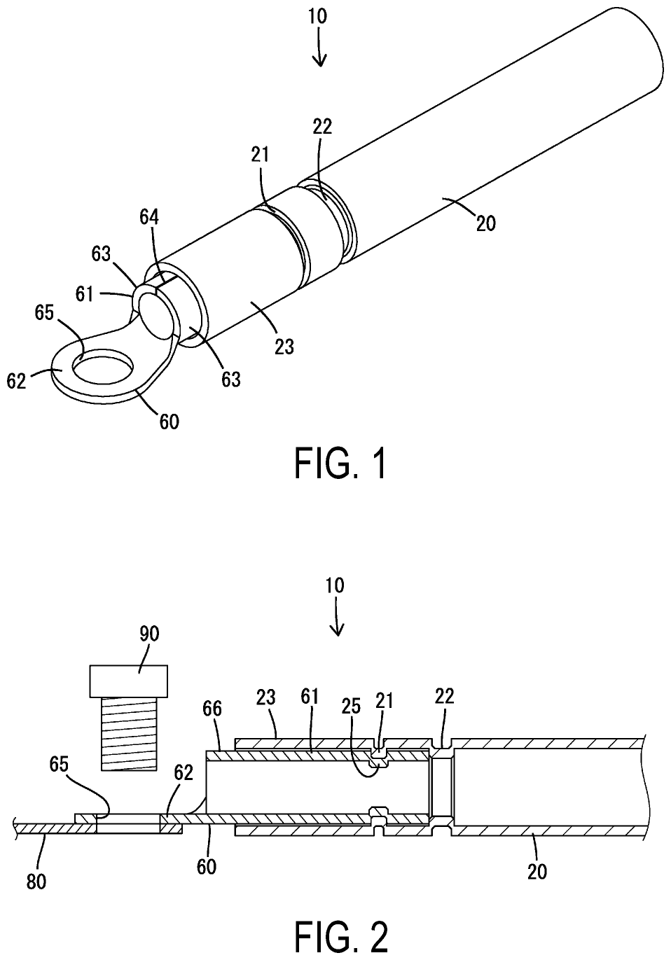

### DETAILED DESCRIPTION OF EMBODIMENTS

Preferred modes for implementing the invention are indicated below.

The counterpart connection part may be planar and connected integrally with the pipe connection part. Through this, it is possible to easily produce the counterpart connection part and the pipe connection part through punch processing or the like of a metal plate.

### Embodiment 1

Below, Embodiment 1 will be described with reference to the drawings. A conductive member 10 according to Embodiment 1 comprises a wire harness laid out in an automobile such as, for example, a hybrid automobile, an electric automobile or the like, and is provided with a pipe 20 and a terminal fitting 60 that can be connected to each other. The pipe 20 and the terminal fitting 60 are both made of conductive metal, and have the rigidity to maintain a fixed shape and the electroconductivity to create an electric circuit.

The pipe 20 forms a main arrangement section of the conductive member 10, and is connected to an undepicted counterpart conductor part separate from the terminal fitting 60, at the end on the opposite side from the side to which the terminal fitting 60 is connected. This pipe 20 is made of a conductive metal, the primary component of which is aluminum, copper or the like, and forms a pipe shape that is elongated and has a circular cross-section. As the pipe 20, it is possible to use one that is formed in a tubular shape (pipe shape) through extrusion or the like.

The pipe 20 shown in the drawings is in a state extending straight in the lengthwise direction, but may be in a shape having bends in accordance with the harness route. Such bends can be easily bent by a bender machine.

The pipe 20 has a concave section 21 as a connection part with respect to the terminal fitting 60 on the end side to which the terminal fitting 60 is connected, and also has a depression 22 positioned such that its distance from the terminal opening end is farther than that of the concave section 21.

The concave section 21 has a U-shaped cross-section indented inward in the radial direction along the entire circumference of the pipe 20, and is positioned at a position slightly separated from the terminal opening end of the pipe 20. This concave section 21 is formed through plastic deformation into a crushed state by a swaging process, after the terminal fitting 60 is connected to the pipe 20.

The depression 22 has a U-shaped cross-section indented inward in the radial direction along the entire circumference of the pipe 20, and is formed so to be longer in the lengthwise direction of the pipe 20 (the left-right direction in FIG. 2) and also deeper in the direction of thickness of the pipe 20 (the up-down direction in FIG. 2, the same as the radial direction) than the concave section 21. This depression 22 is formed through plastic deformation into a crushed state by a swaging process, before the terminal fitting 60 is connected to the pipe 20.

The terminal fitting 60 is formed integrally by a conductive metal plate being punched into a prescribed shape and then bent, and preferably is formed of the same type of material as the pipe 20. Specifically, the terminal fitting 60 is in a shape extending in the lengthwise direction from one end to the other end, and has a cylindrical pipe connection part 61 at one end side and a flat counterpart connection part 62 at the other end side.

The pipe connection part 61 is internally fitted into the end side of the pipe 20, the outer diameter of the pipe connection part 61 being substantially the same as the inner diameter of the pipe 20, or having a slightly smaller dimension than the inner diameter of the pipe 20 (excluding the depression 22). In addition, the outer diameter of the pipe connection part 61 is larger than the inner diameter of the depression 22. This pipe connection part 61 has half arc parts 63 that stands up integrally on both left and right sides from the bottom section, and is formed so that the top sides of the half arc parts 63 are matched with each other along their entire length via facing edges 64.

On the end side of the pipe 20, a wrap region 23 is formed into which the pipe connection part 61 is internally fitted. The wrap region 23 is positioned immediately in front of the depression 22, and the concave section 21 is positioned in the wrap region 23.

The counterpart connection part 62 has an annular shape in plan view, and protrudes in the lengthwise direction from the bottom portion, in the drawing, of the other open end of the pipe connection part 61, and has a circular connection hole 65. As shown in FIG. 2, this counterpart connection part 62 is in a state positioned so as to overlap a flat counterpart conductor part 80, and is connected to the counterpart conductor part 80 by fastening a bolt 90 that passes through the connection hole 65. In this case, the counterpart connection part 62 overlaps the bottom part of the pipe connection part 61 with substantially no step, and the lengthwise dimension of the counterpart connection part 62 is shorter than that of the pipe connection part 61.

Next, effects of Embodiment 1 will be described.

During assembly, the pipe connection part 61 of the terminal fitting 60 is inserted into the pipe 20. When the one open end (the tip in the insertion direction) of the pipe connection part 61 abuts against and is stopped by the end surface portion of the depression 22 of the pipe 20, further insertion of the terminal fitting 60 is restricted. At this time, the pipe connection part 61 is internally fitted into the pipe 20 with the exception of a portion of the other end side (exposed part 66), and is positioned so that its outer surface can make contact along the inner surface of the pipe 20.

Next, a swaging process is performed on the wrap region 23 between the depression 22 and the open end of the pipe 20, and the concave section 21 indented radially inward is formed along the entire circumference.

Simultaneously with the concave section 21 being formed by the above-described swaging process, a contact part 25 opposite the concave section 21 is crushed and formed in the pipe connection part 61. The contact part 25 has the same cross-sectional shape as the concave section 21, and is formed in a state indented radially inward along the entire circumference of the pipe connection part 61. Through this, the concave section 21 and the contact part 25 overlap and contact approximately linearly along the circumferential direction, and the pipe 20 and the terminal fitting 60 are electrically and mechanically connected. An undepicted insulating material straddling the pipe 20 and the exposed part 66 of the pipe connection part 61 may cover the conductive member 10. As the insulating material, for example, a resin layer, a heat-shrink tube, insulating tape, a rubber tube or the like can be used.

As described above, with Embodiment 1, the terminal fitting 60 is directly connected to the pipe 20 via its own pipe connection part 61, so not only is a separate connection member not interposed between the terminal fitting 60 and the pipe 20, a core wire or the like can also be omitted, so the number of parts can be reduced. In addition, positional fluctuation between the pipe 20 and the terminal fitting 60 substantially does not occur. As a result, it is possible for the pipe 20 to easily reach a position connectable to the counterpart conductor part at the end on the side opposite the side where the terminal fitting 60 is positioned, so it is possible to confirm the connection position of the end.

In addition, the pipe connection part 61 has a circular cross-section that can fit in the pipe 20, and can be inserted into the pipe 20, so it is possible to smoothly accomplish the work of connecting the terminal fitting 60 and the pipe 20. Moreover, the pipe connection part 61 has a contact part 25 that contacts the pipe 20 approximately linearly along the circumferential direction, so it is possible to avoid unnecessary increases in contact resistance.

In addition, the pipe connection part 61 is fitted inside the pipe 20, the concave section 21 is indented radially inward in the pipe 20, and the contact part 25 has a shape that indents in correspondence with the concave section 21, so it is possible to avoid the conductive member 10 becoming larger in the radial direction. Moreover, through the engagement stop action between the contact part 25 and the concave section 21, it is possible to realize a mechanical connection, and it is possible to prevent the terminal fitting 60 from becoming misaligned with respect to the pipe 20.

Furthermore, the depression 22 that indents radially inward is formed in the pipe 20, and one end of the pipe connection part 61 is stopped at the depression 22 inside the pipe 20, so it is possible to easily confirm the amount of insertion of the pipe connection part 61 into the pipe 20.

And furthermore, the counterpart connection part 62 has a flat shape integrally connected to the pipe connection part 61, so the terminal fitting 60 composed of the counterpart connection part 62 and the pipe connection part 61 can be easily produced through a metal plate punching process.

### Other Embodiments

Below, other embodiments are described simply.

(1) As the pipe, it is possible to use one in which a plate material made of conductive metal is bent so as to form a tubular (pipe) shape.

(2) In Embodiment 1, the pipe connection part was formed into a hollow shape, but as a reference, the pipe connection part may be formed into a solid shape.

(3) In Embodiment 1, the pipe connection part had a shape integrally connected to the counterpart connection part, but in the case of this invention, the pipe connection part may be separate from the counterpart connection part and be integrated with the counterpart connection part through welding or the like.

(4) In Embodiment 1, the pipe connection part was fitted internally in the pipe, but as a reference, the pipe connection part may be fitted externally on the pipe.

(5) In Embodiment 1, the counterpart connection part was formed into a round terminal shape, but in the case of this invention, the counterpart connection part may be formed into a female terminal shape having a box-shaped connection section so that a male terminal fitting can be inserted and connected therein as a counterpart connection part, or may be formed into a male terminal shape having a tab so as to be insertable and connectable to a female terminal fitting as a counterpart connection part.

(6) In Embodiment 1, the concave section was formed through a swaging process, but in the case of this invention, the concave section may be formed by pressing with a pair of metal molds that can be separated in the radial direction. When this is done, the concave section is formed on both sides of the pipe in the radial direction, and similarly the connection part is formed on both sides of the pipe connection part in the radial direction.

(7) In Embodiment 1, the depression was formed through a swaging process, but in the case of this invention, the depression may be formed by pressing with a pair of metal molds that can be separated in the radial direction. When this is done, the depression is formed on both sides of the pipe in the radial direction.

### EXPLANATION OF SYMBOLS

10 Conductive member

20 Conductive pipe

21 Concave Section

22 Depression

25 Contact part

60 Terminal fitting

61 Pipe connection part

62 Counterpart connection part

80 Counterpart conductor part

What is claimed is:

1-5. (canceled)

6. A conductive member comprising:
a conductive pipe; and
a terminal fitting having a first end and a second end, the first end being a hollow pipe connection part that is connected to the pipe, and the second end being a counterpart connection part that is connectable to a counterpart conductor part; wherein:
the pipe connection part has a contact part that has a circular cross-section, is fitted into the pipe, and contacts the pipe along a circumferential direction of the pipe;
the pipe has (i) a concave section that indents radially inward near one end of the pipe and (ii) a depression that indents radially inward, the depression being positioned at a greater distance, than the concave section, from the one end of the pipe, and the depression being formed deeper, than the concave section, in a radial direction of the pipe;
an end of the pipe connection part abuts against and is stopped by the depression; and
the connection part has a shape that indents radially inward in correspondence with the concave section.

7. The conductive member according to claim 6, wherein the counterpart connection part has a flat shape and is connected integrally to the pipe connection part.

8. The conductive member according to claim 6, wherein the concave section and the depression both have U-shaped cross-sections.

9. The conductive member according to claim 6, wherein the concave section and the depression are both formed along an entire circumference of the pipe.
